(19) United States
(12) Patent Application Publication
(10) Pub. No.: US 2009/0269718 A1
(43) Pub. Date: Oct. 29, 2009

(54) Oral implant placement system

(76) Inventor: Gary Allan Duncan, Dublin, OH (US)

Correspondence Address: ELEY LAW FIRM CO., 7870 OLENTANGY RIVER RD, SUITE 311, COLUMBUS, OH, 43235, US

(21) Appl. No.: 12/148,996

(22) Filed: Apr. 24, 2008

(51) Int. Cl. A61C 8/00

(52) U.S. Cl. 433/174

(57) ABSTRACT

The Oral Implant Placement System, while using a stent will allow a surgeon to place a dental implant in the mandible and/or maxilla bone(s). The Oral Implant Placement System is best implemented in the placement of a surgical dental implant perfectly parallel to other dental implant(s) and root structures. The Oral Implant Placement System, while using a stent will allow a surgeon to place dental implant(s) at a predetermined depth within the mandible and/or maxilla of a patient undergoing surgery.

### CROSS-REFERENCE TO RELATED APPLICATIONS

U.S. Ser. No. 11/807,366, U.S. Ser. No. 11/807,360, U.S. Ser. No. 11/807,377. The stated application numbers benefit the Oral Implant Placement System as collectively these tools are placed into use throughout the system.

### STATEMENT REGARDING FEDERALLY SPONSORED RESEARCH OR DEVELOPMENT

Not Applicable

### REFERENCE TO SEQUENCE, A TABLE, OR A COMPUTER PROGRAM LISTING COMPACT DISK APPENDIX

Not Applicable

### BACKGROUND OF THE INVENTION

The Oral Implant Placement System is placed into use during a sequence of steps for the use of a implant stent and is suggested to be placed under Class 433, Dentistry, as this class is a specific class under the broader class of Surgery and includes methods directed to or including specific dental steps whereas the use of this device ultimately facilitates the replacement of teeth. The Oral Implant Placement System is suggested to be assigned the subclass 72, having gauge or guide: This subclass is indented under subclass 25. Apparatus including either (a) dimensional or angular reference, or (b) a surface adapted to be contacted by another device (e.g., a tool) to govern the movement of the device.

The Oral Implant Placement System is placed into use over a number of steps as resolution in solving notable problems in the process of both favorably manufacturing a surgical dental implant stent in the dental lab in order to ultimately surgically placing dental implants in the patients mouth using the aforementioned stent. Because the Oral Implant Placement System or anything to serve it's exact purpose has not previously been invented, currently dental implant stents in addition to any other means used by surgeons to place any number of dental implants in a patient's mouth are unable to be manufactured as to allow such surgeons to place a dental implant parallel to other implants and or existing teeth and at exact predetermined depths drilled by a surgeon on the arch of the mandible or maxilla of a patient undergoing surgery. When a dental implant analog is not placed parallel to other dental implant analogs, final restorations are much more difficult to manufacture and the longevity of a final restoration is shortened. Without the Oral Implant Placement System and/or the process of its use, surgical dental implant stents are unable to be manufactured as to allow surgeons to place a dental implant at a predetermined depth decided upon by the surgeon or allow a dental lab technician to manufacture a surgical dental implant stent that can be used to fabricate the final dental implant restoration that will stay in the patient's mouth. When surgeons have no means to accurately follow through with making a fissure to place a dental implant at a predetermined depth, such surgeons when making this fissure will pass through the bone of the mandible or maxilla and be required to find a new site as well as restore the damaged area causing additional time for a patient undergoing the procedure to heal and recover. Currently, surgical dental implant stents are not manufactured as to allow a surgeon to immediately place a final dental implant restoration. The advantages to this system will allow a patient to enter surgery for implants and have the final product placed at the end of implant surgery. The final product could be of two types. The first type is a hybrid denture composed of a metal bar made with the denture teeth processed to the bar with acrylic and later screwed into the implants. This technique under current process normally takes weeks to complete. The second type is commonly known as a crown or porcelain tooth or teeth that is/are placed on a metal structure that is later screwed into the implants. Both of the aforementioned are final restorations.

### BRIEF SUMMARY OF THE INVENTION

The Oral Implant Placement System is placed into use during the manufacturing a surgical dental implant stent. The Oral Implant Placement System is used by implementing the designed steps for the use of tools associated with the numbers U.S. Ser. No. 11/807,366, U.S. Ser. No. 11/807,360, U.S. Ser. No. 11/807,377. The Oral Implant Placement System allows the ultimate manufacture of a dental implant stent that for the first time will allow surgeons to drill with ease and precision to control the depth of placed dental implant(s), while also allowing such surgeons to place dental implant(s) parallel to other dental implant(s) or teeth and immediately place the final dental implant restoration in a patient's mouth that will function in conjunction with dental implants placed using the aforementioned surgical dental implant stent.

The Oral Implant Placement System allows the manufacturing of the aforementioned surgical dental implant stent which allows for dental implant analogs to be placed parallel allowing for increased longevity of a final restoration. The Oral Implant Placement System allows the manufacturing of the aforementioned surgical dental implant stent that also will serve as a guide to a surgeon allowing him or her to place a dental implant at a predetermined depth using a color coordinated tool associated with the number U.S. Ser. No. 11/807,366 and what is currently named the Oral Implant Drill thus leaving no error for correct and desired dental implant placement.

### BRIEF DESCRIPTION OF THE SEVERAL OF THE DRAWING

The above and other objects, features, and advantages will become more readily apparent from the following description, reference being made to the accompanying drawing in which:

FIG. 1 is a vertical cross section view of a dental implant analog placed in a stone model using the system of this invention; FIG. 2 is a vertical cross section view of the final restoration screwed to the model with the implant analogs; FIG. 3 is a vertical cross section view of the transfer screw 15 while placed through the transfer band and screwed into an implant analog; FIG. 4 is a vertical cross section view of the transfer band 16 in position with transfer screw 15; FIG. 5 is a vertical cross section view of a retention post and a light cure clear resin; FIG. 6 is a vertical cross section view of the clear replica of the teeth 25 as it is snapped onto the rubber “o” ring 24. FIG. 6 also represents a section view of a patients tissue; FIG. 7 is a vertical front view partly in section displaying the implant drill guide placed on the patients mouth with a surgical drill being readied to be placed onto the implant driver in accordance with the present invention; FIG. 8 is a vertical front view partly in section displaying the implant drill guide in the patients mouth with the implant being readied to be placed onto the implant driver in accordance with the present invention; FIG. 9 displays the implant being placed in the patients mouth with the driver being threaded into the guide in accordance with the present invention; FIG. 10 displays the final prosthesis placed into the implant in the patients mouth in accordance with the present invention.

### DETAILED DESCRIPTION OF THE INVENTION

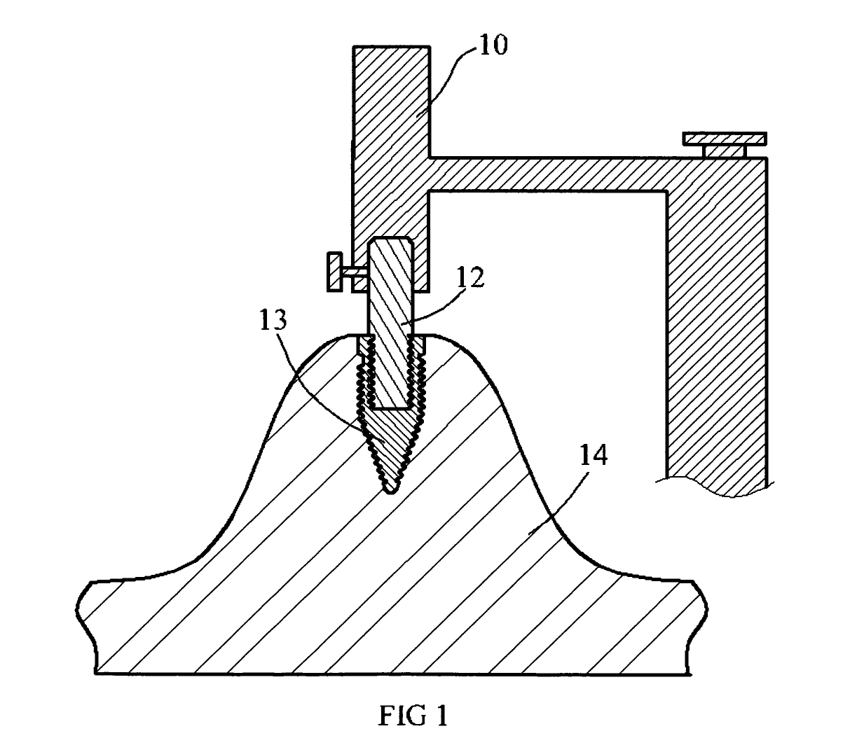

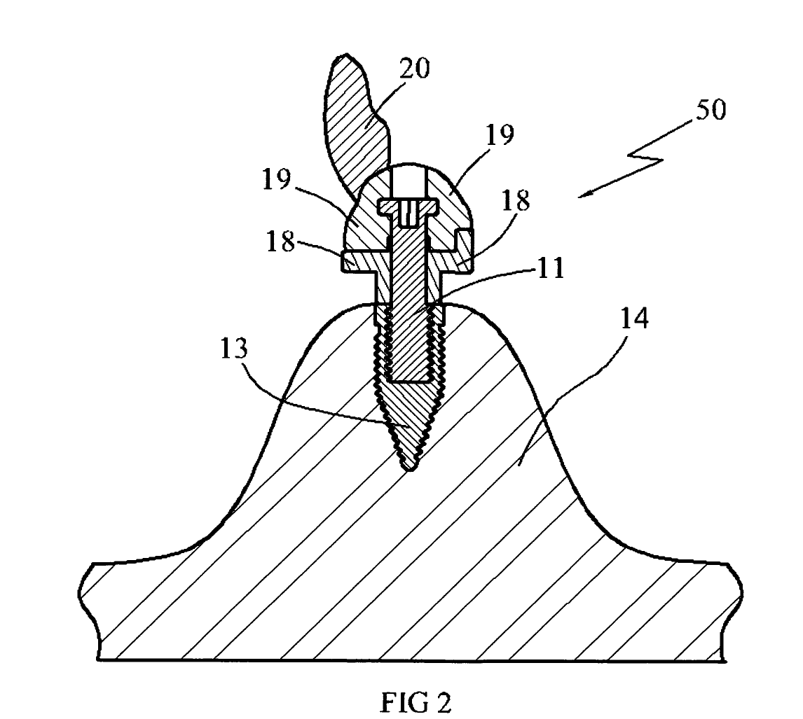

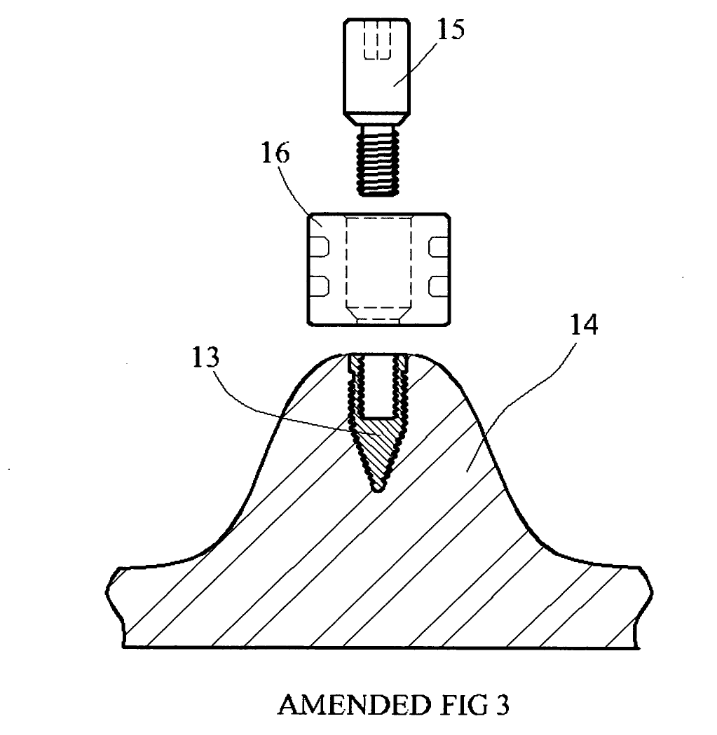

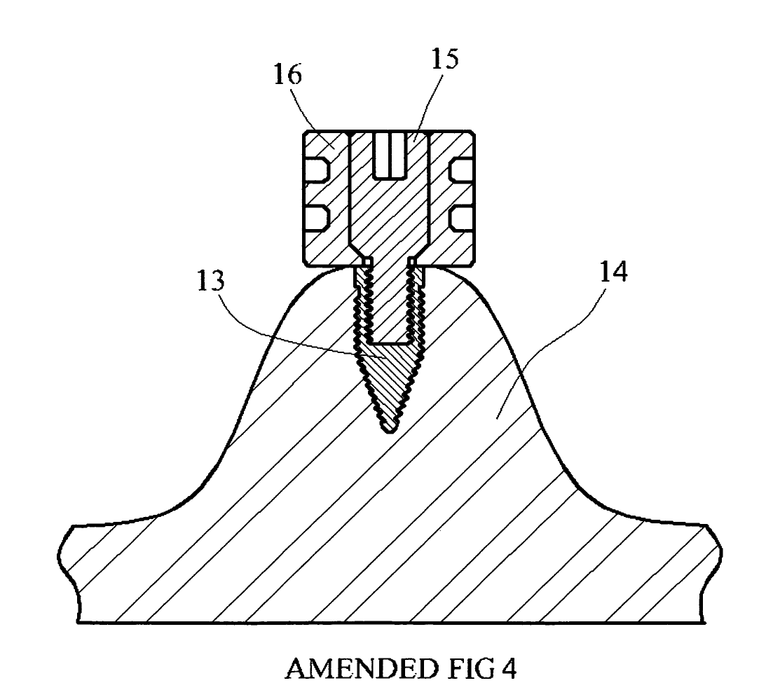

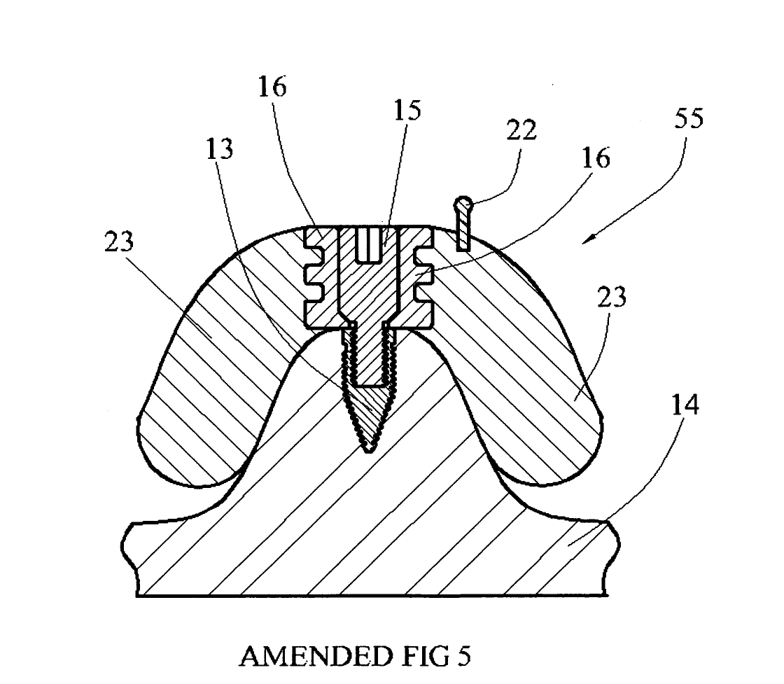

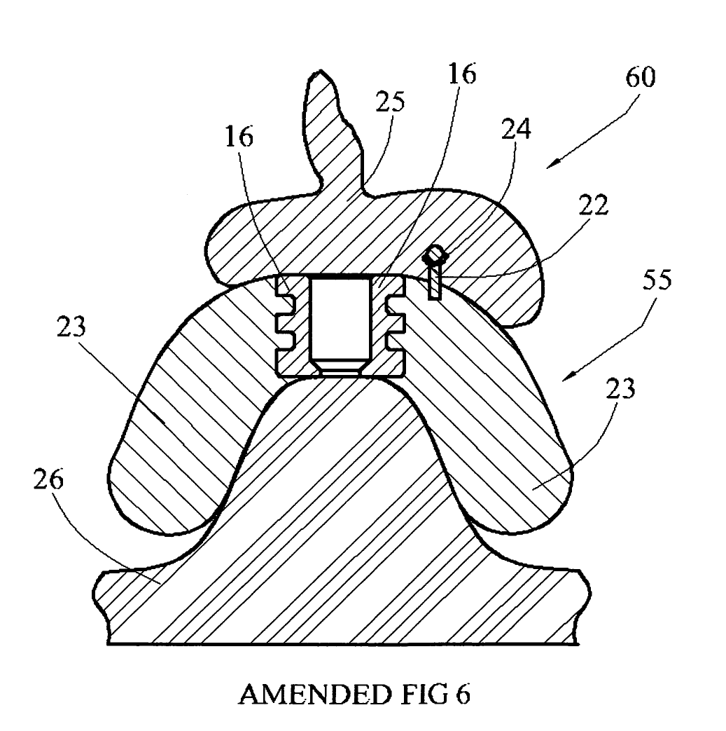

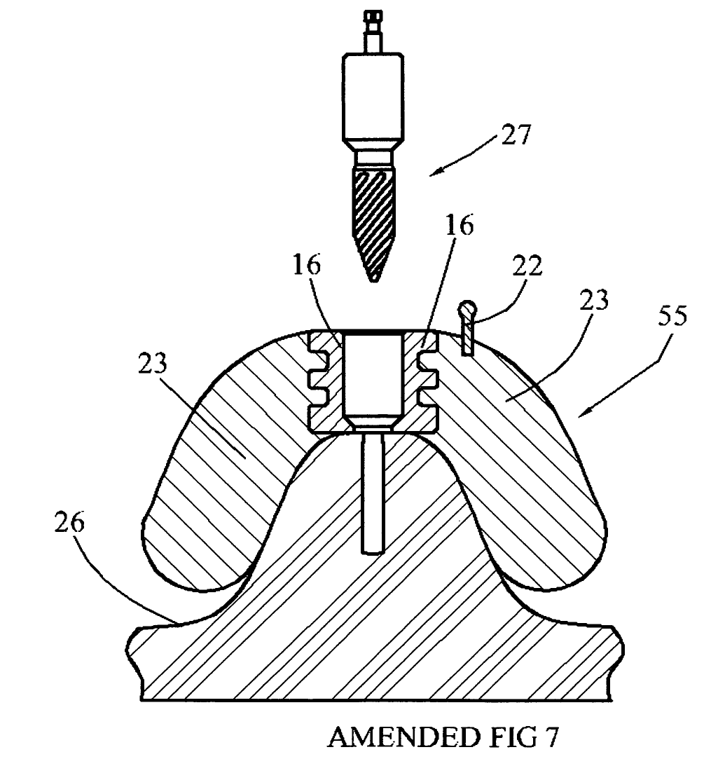

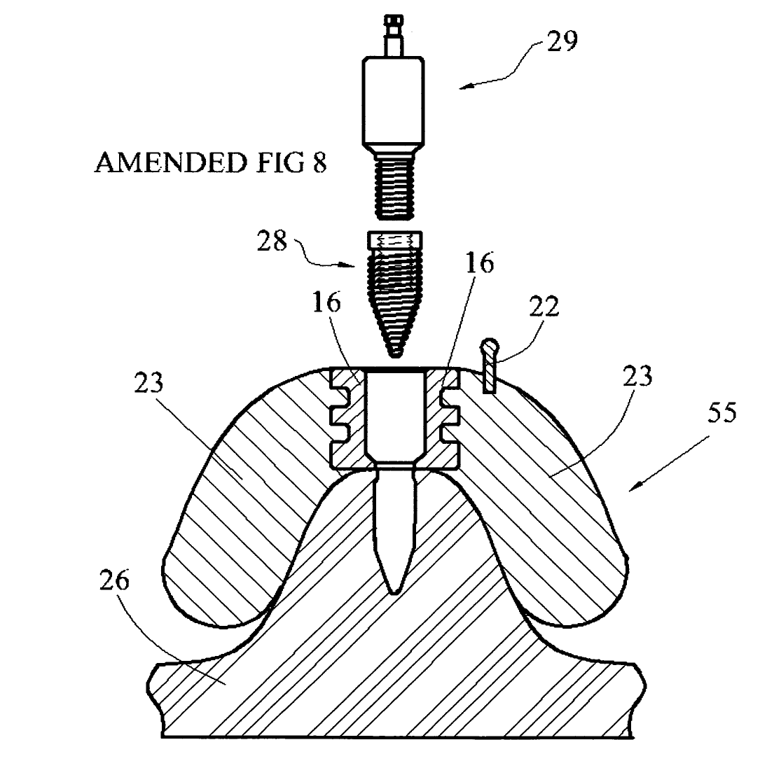

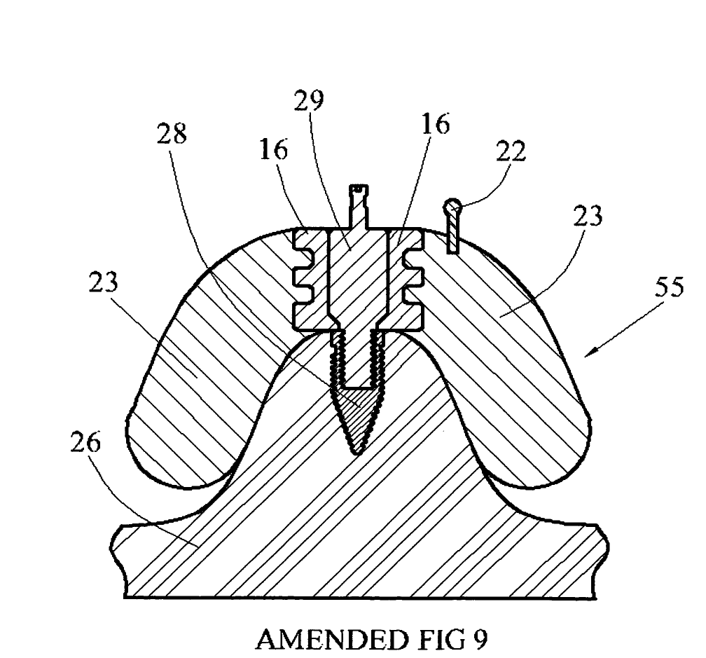

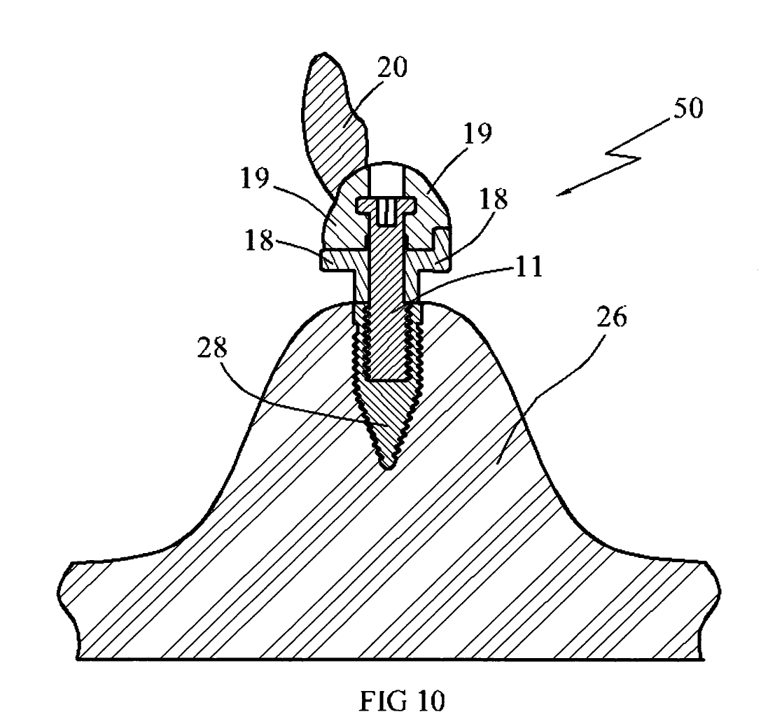

The Oral Implant System is best carried out in the following steps. The technique begins as the oral surgeon decides where to place the oral implants within a patients maxilla and/or mandible by using x-rays of the patients arches. Once the surgeon determines the location and depth of the oral implants into the patients bone, impressions for the mandibular and maxilla arches are taken and articulated. Next, the surgeon marks the model distinguishing the desired placement of implants and size of implants he or she has selected to use and then relays this information to the technician. The technician next places the marked stone model on a surveyor's table such as that which is used in making partials and sets the ridge of the patient somewhat level. As seen in FIG. 1, by using a surveyor 10, and the positioning tool associated with the number U.S. Pat. No. 11/807,360, 12, the implant analog 13 can be placed perfectly parallel into the stone model 14. The technician can now wax the implant analog(s) 13 to the model 14 having the top of the implant ½ mm below the surface of the crest of the ridge. After all the implants are placed into the model, then impression pins are screwed into the implant analogs and duplicating material over these pins in order to duplicate the model. Once the duplicating material has set the material is removed and set aside. Next, the pins and implants are taken out of the waxed up model and cleaned to be then placed into the duplicating impression. This impression can be poured with all stones or both stone and a common soft putty. This model 14 now has the implant analog(s) 13 exactly where the surgeon had marked. All models and the articulations are approved by the surgeon allowing the technician to proceed with the manufacturing of the final restoration.

The appliance is made using non-engaging waxing sleeves with the gold copings. As seen in FIG. 2, the final restoration(s) 50 will be made where the appliance is screwed into the implant analog(s) 13 using an implant screw 11. This appliance is completed and placed on the model. Using base plate wax, place the wax about 3 mm from the cervicals of the teeth 20 which are set in acrylic 19 toward the model making the wax covering the entire area. Next, this model with wax is placed into a pour type denture flask with reversible hydracolloid. After the material sets, open and take out the model and save the hydracolloid impression in water.

As seen in FIG. 3, next, the tool associated with the number U.S. Ser. No. 11/807,377, 15, is placed through the tool associated with the number U.S. Ser. No. 11/807,366, 16, and screwed into the implant analog 13 that is on the model 14. As seen in FIG. 4, the color-coded band associated with the number U.S. Pat. No. 11/807,366, 16, over the tool associated with the number U.S. Ser. No. 11/807,377, 15 down tight into the analog 13. The color-coded band 16 coordinates with a color-coded drill, which allows for predetermined placement depth and size of the oral implant at a later point within the process of the system of this invention.

Next, the technician uses wax to block out any undercut areas. As seen in FIG. 5, with a light cure system, we cover the ridge with the light cure material 23 including the color-coded bands. Next, we cover the ridge area and bring the material 23 down to the peripheries. Also, at this time we place two attachments, post for o-rings 22, to the light cure system, and one post in the posterior regions bilaterally. Next, cure the light cure resin 23. Next, take out the entire model and unscrew the tool associated with the number U.S. Ser. No. 11/807,377, 15, leaving the color code band of the tool associated with the number U.S. Ser. No. 11/807,366, 16 in the clear material 23. This becomes the clear surgical guide to be later sutured into the mouth of a patient in order to keep it stable and unable able to move.

With this clear surgical guide on the model, place the other half of the attachments onto the two attachments, thus placing two in the posterior section. Paint the entire model and surgical appliance 55 with plaster separator and now place this entire model and appliance 55 into the hydracolloid impression taken earlier. Next, pour clear acrylic into the flask. As seen in FIG. 6, after processing the clear acrylic, open the flask and the pour acrylic will come off the light cure system quite easily providing the technician with the final product replicated with clear acrylic 25 held onto the surgical guide with two attachments 22 with the rubber “o” ring 24. The top portion will snap off and on because of the attachments 22.

The system is now complete, where the top clear replica of the teeth 25 will be snapped into the surgical guide 22. The surgeon can now place the guide into the mouth 26 and position the appliance in centric position against the opposing denture or natural teeth. Next, the surgeon sutures the surgical guide in this position in the mouth 26. After the guide is in place, the surgeon removes the top portion off the surgical guide 25. As seen in FIG. 7, next, the surgeon uses a implant drill 27 with the same color-code as the tool associated with the number U.S. Ser. No. 11/807,366, 16. As seen in FIG. 8, the tool associated with the number U.S. Ser. No. 11/807,366, 16 that is in the guide determines the depth to be drilled into the patients bone structure and also corresponds to the implant 28 to be placed using its accompanying male threaded placement appliance 29. As seen in FIG. 9, the tool associated with the number U.S. Ser. No. 11/807,366, 16, stops the drill at the exact predetermined depth decided by the surgeon as the aforementioned tool does not allow the drill to pass this depth due to precise working relationship of the two tools. This process is repeated with respect to the desired number of implants to be placed determined by the surgeon. The color code band 16 will place the implant. As seen in FIG. 10, the implant 28 is now ready to receive the implant screw 11 and the final restoration 50.

What is hereby claimed is:

1. Comprised of the cited tools, their uses, as well as additional procedures, a oral implant placement system utilizing a dental implant stent that is surgically anchored into a patients mouth will create a cavity in the maxilla and/or mandible bone(s) that will then allow for the surgical placement of dental implant(s) in a patients mouth.

2. The oral implant placement system defined in claim 1 will allow surgical dental implants to be set in the mandible and/or maxilla bone(s) of a patient undergoing surgery just as they were in a model replicating the said patient's mandible and/or maxilla bone(s) that was made prior to surgery.

3. The oral implant placement system defined in claim 1 will allow for the creation of a cavity, with the use of a custom manufactured stent, in the maxilla and/or mandible bone(s) in the predetermined anatomical location decided by a surgeon.

4. The oral implant placement system defined in claim 1 will allow for the creation a cavity, with the use of a custom manufactured stent, in the maxilla and/or mandible bone(s) at depth within the maxilla and/or mandible bone(s) predetermined by a surgeon.

5. The oral implant placement system defined in claim 1 will allow for the creation a cavity, with the use of a custom manufactured stent, in the maxilla and/or mandible bone(s) at perfect parallelism to other implants or root structures.

6. The oral implant placement system defined in claim 1 can be comprised of tools within the system that can be color-coded distinguishing a predetermined working relationship.

7. The oral implant system defined in claim 1 will replace all other dental implant placement systems that currently use or do not use stents.

8. The oral implant system defined in claim 1 will allow for the manufacturing of a surgical dental implant stent that will allow a surgeon to place the final dental implant restoration immediately after surgery into a patient's mouth that will function in conjunction with the dental implant(s) previously placed in the mandible and/or maxilla bone(s) while using the aforementioned surgical dental implant stent.

9. The oral implant system defined in claim 1 will reduce complications, time of implant placement, inaccuracies of implant placement and will be then easier to drill accurate fissures in a patients maxilla and/or mandible for implant placement.
